(19) United States
(12) Patent Application Publication
(10) Pub. No.: US 2012/0246264 A1
(43) Pub. Date: Sep. 27, 2012

(54) Data Exchange Between Communicating Computing Equipment Using Differential Information

(76) Inventors: Peter Bodorik, Halifax (CA); Dawn Natalie Jutla, Halifax (CA); Muhammad Suhaib Qaiser, Halifax (CA)

(21) Appl. No.: 13/366,328

(22) Filed: Feb. 5, 2012

Related U.S. Application Data
(60) Provisional application No. 61/440,981, filed on Feb. 9, 2011.

(51) Int. Cl. G06F 15/16

(52) U.S. Cl. 709/217

(57) ABSTRACT

Two pieces of communicating computing equipment (parties), including computers, routers, and mobile computing devices, having a communication function between the two parties. The sender/receiver store the most recent messages sent/received. The sender modifies a new message, to be sent, by comparing it with the previously sent message to the receiver and by removing from the new message those parts that were already sent in the previous message and also including in the modified message differential information describing the differences between the new message and the previous message. When the receiver receives the modified message from the sender, the receiver compares the received modified message to the previously received message, and using this comparison and the differential information included in the received modified message, the receiver derives the new message used by the sender to create the modified message actually sent.

### CROSS-REFERENCE TO RELATED APPLICATIONS

This application, for non-provisional patent, is for the previously filed provisional patent with application No. 61/440,981, filed on Feb. 9, 2011. Thus the benefit of the filing date of the provisional application (No. 61/440,981) is claimed for this non-provisional patent application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### REFERENCES CITED

### U.S. Patent Documents

| Pat. #s | Titles |
|---|---|
| Pat. 7,610,460 | Buffer updates and data evacuation in a storage system |
| | using differential snapshots |
| Pat. 7,584,379 | Mobile terminal and software update method |
| Pat. 7,756,833 | Method and system for synthetic backup and restore |
| Pat. 7,784,098 | Snapshot and restore technique for computer system |
| | recovery |
| Pat. 7,788,532 | Storage controller, and control method of the same |
| Pat. 7,099,903 | Method and system for data processing with data backup |
| Pat. 7,130,914 | Database synchronization system and method |
| Pat. 7,302,454 | Method and system for data processing with data backup |
| Pat. 7,302,535 | Data replication in a storage system |
| Pat. 7,421,550 | Storage system and storage system management method |
| Pat. 7,490,006 | Method of generating map update process data, map |
| | update method, and map update apparatus |
| Pat. 7,650,369 | Database system management method and database |
| | system |
| Pat. 7,707,373 | Storage system and backup method |
| Pat. 7,747,662 | Service aware network caching |
| Pat. 7,752,390 | Disk array apparatus and control method for disk array |
| | apparatus |
| Pat. 7,757,114 | Data synchronization of multiple remote storage after |
| | remote copy suspension |

### Other References

“Run-Time Load Balancing System on San-Connected PC Cluster for Dynamic Injection of CPU and Disk Resource” by K. Goda, et al. pp. 182-193 of Proceedings of 13.sup.th International Conference on Database and Expert Systems Applications (DEXA 2002), September 2002. cited by other.

### BACKGROUND

1. Technical Field

The present invention relates to exchange/transfer of messages between two pieces of communicating computing equipment, including computers, routers, switches, mobile computers, and/or mobile computing devices, and a method to modify the content of a message to be transferred in order to reduce its size, particularly when the content of one message does not differ much from the content of a previous message.

2. Prior Art

Message exchange is one of the basic operations performed by computing systems and it occurs between systems or sub-systems, computers, communication equipment, and/or mobile computing devices. Exchange of messages within, a possibly multi-processor, computing system is achieved by utilization of functionalities provided by the operating system while exchange of messages between two pieces of computing equipment connected via some type of network is achieved by using a suite of communication protocols, such as the TCP/IP suite. In the following, “parties” will be used as a generic term to refer to the systems or sub-systems, computers, communication equipment, and/or mobile computing devices, that exchange messages. Communication protocols define rules/steps/instructions to be followed by the communicating when exchanging data. The protocols are organized in layers and each protocol specifies how data units of that layer are transferred and which properties are supported. For instance, a Data Link layer provides for transfer of frames, the data units of the Data Link layer, between two parties. The Network Layer of the TCP/IP suite of protocols, which utilizes the services of the Data Link layer, provides for transfer of packets, the data units of the Network Layer, between network nodes and computing systems, where network nodes are usually routers, switches, or computing systems. The TCP protocol, of the Transport layer of TCP/IP suite of protocols, which utilizes the services of the Network layer, describes how segments are transferred reliably, that is without errors and in the correct sequence, between two parties, typically computers and/or mobile computing devices. The widely used HTTP protocol, used in web applications, uses the services of the Transport Layer to exchange messages between a server and a, potentially mobile, computing equipment. The data unit encapsulation is utilized in the layering of the protocols in a suite: the HTTP messages are transported within the segments of the Transport Layer. The Transport Layer segments include, in addition to transporting the HTTP message, information pertaining to the transport of the segment itself, information related to identification of the protocol and its version and addressing and reliability information used by the Transport layer. The segment itself is transported within a packet of the Network Layer, which is transported within a frame of the Data Link layer. Furthermore, there are a number of protocols that may be used at a particular layer, depending on which technologies are in use. In the Data Link layer, for instance, different protocols are used if communication is wireless as opposed to the hard-wired communication, such as using an Ethernet cable. Although different protocols at different layers may call data units being transferred using different terminology, such as fragments, packets, segments, or messages, these are generically referred to as data units.

Many methods are applied in exchange of data units for various purposes, such as cryptographic methods for encryption/decryption, methods to calculate checksum for error detection and/or correction, and compression methods to reduce the size of data. Furthermore some of the methods may be applied by various protocols at different levels, such as a method to calculate and include a checksum in a data unit may be used at the Data Link layer, or higher layers, such as the Network or the Transport layer.

The Differential Snapshots technique has been used widely for storage of versions of files. It is based on the observation that when a new version of the file is created, most of the time the changes between the new version and the old version are not large and hence, instead of storing a whole copy of the new version of the file, only the differential information, describing how the new version differs from the old version, is stored, resulting in reduction of storage space requirements. When the new version has to be accessed, it is re-created from the old version by using the differential information. The Differential Snapshots technique has also been used to reduce the size of data transferred between by an application when reading and writing a file stored on a storage device accessed by communication over a network. The technique is based on the observation that applications tend to read data in files much more than to write to them. When an application accesses the file, or portions thereof, a copy of the file (or portions) is made by transferring it from the storage device into the memory of the computing (sub)system which executes the application. Any writes to the file by the application are made to the copy in the memory and that copy eventually needs to be transferred to the storage device. However, since only some of the portions of the file have been written to by an application, instead of transferring the whole file from the memory to the storage device, only differential snapshots, which describe the changes to the file, are transferred from the memory to the storage device. To facilitate identifying which portions, of the copy of the file in the memory of the computing (sub)system executing the application, have been written to by the application, to create the Differential Snapshots, and to transfer them to the storage device, the local file system is modified and, correspondingly, the storage system is also modified to use the Differential Snapshots technique in order to record the writes by the application to the file.

The Differential Snapshots technique has also been applied to Database (DB) systems when applications retrieve and manipulate/write data stored in tables/relations that are stored on storage devices, where tables/relations correspond, as far the application of the Differential Snapshots technique is concerned, to files. It has also been used in patents, applicable to various domains, which are referenced by this patent application in the References Cited section.

The above two example applications of the usage of the Differential Snapshot method demonstrate two of its important properties: the method is embedded within applications and relies on long-term storage of an older version of data and Differential Snapshots for the purposes of reconstruction of the newest version of the data. Thus, to use the Differential Snapshot method, both the application editing the data and also the software used for permanent storage of the data must include the Differential Snapshot method. For instance, in the example of the file versioning discussed above, the Differential Snapshot method must be used by the file editor and also file storage system. In the DB example above, the program code retrieving/storing the data from the DB and the DB content itself must use the Differential Snapshot method itself. Also, in both cases, what is permanently stored is the older version of data and also snapshots that contain the differential information.

Although the method of invention of this application also uses differential information, it differs from the Differential Snapshots in two major points. One is that the differential information is temporary in that it is stored only between exchanges of two successive messages between a sender and a receiver—thus the differential information is not stored permanently together with a previous version of the data as it is in the Differential Snapshot method. Furthermore, the method of the invention is used by two communicating end-points, sender and a receiver, such as in various layers of the communication protocols, and thus the software programs that actually create/edit or store the data need not be modified to use the method of invention.

### SUMMARY OF THE INVENTION

Two pieces of computing equipment, one or both of which may be mobile, referred to as parties, which communicate to exchange data, use the method to reduce the size of transferred data by: (a) the sender deriving and sending modified data to the receiver, instead of the original data, and (b) the receiver of the modified data reconstructing the original data by using (i) the received modified data and (ii) data previously received.

The method can be used by software used for sending and receiving data units at any of the layers of the protocol suite used for exchange of data units, such as at the HTTP, TCP, or the Data Link layers, or it can be used by programs which utilize the operating system, or other programs that provide for sending and/or receiving of data units, wherein (1) either the data units are received by the receiver in the order that they were sent by the sender or (2) the sender and receiver incorporate in the data units information, such as sequence numbers, that enable the receiver to order the received data units into the order in which they were sent by the sending party. The case (1) is usually achieved by one of the protocols, in the suite of communication protocols, used to exchange data units.

The method is self-starting in the sense that when the first data unit is sent, then the differential information identifies that there is no previous message.

### DESCRIPTION OF DRAWINGS

FIG. 1 is a diagram illustrating an example of two parties, one sender and one receiver, according to an embodiment of this invention wherein the sender makes a copy of the new data-unit and then uses the new data-unit and the previous data-unit to (i) create a modified data-unit by removing those parts of the data-unit that already appeared in the previous data-unit, and to (ii) augment the modified data-unit with Differential Information, which describes the difference between the data-unit and the previous data-unit. The modified data-unit is transferred to the receiver. Also, the copy of the new data-unit becomes the previous data-unit when the next data unit is being sent from the sender to the receiver. The receiver uses (i) the modified data-unit, including the Differential Information contained therein, and (ii) the previous data-unit to derive the new data-unit, from the sender derived the modified data-unit. Once the receiver derives the new data-unit it makes a copy of it and that copy becomes the previous data-unit when the next modified data-unit is received from that sender.

FIG. 2 is a flowchart showing the method of invention used by the sender.

FIG. 3 is a flowchart showing the method of invention used by the receiver.

FIG. 4 is a diagram illustrating an example of two parties according to an embodiment of this invention wherein the sender is represented by an application, such as a browser, that uses HTTP, which in turn uses TCP/IP, for sending a message and the receiver is also represented by an application program, such as a web server that uses HTTP, which uses TCP/IP, for receiving the message from the sender. The figure does not explicitly show whether the application or the HTTP of the sender/receiver use the method of invention.

FIG. 5 is a diagram illustrating an example of two parties according to an embodiment of this invention, wherein the sender is a browser, with plug-ins, that uses HTTP for communication, while HTTP uses TCP/IP, for sending a message. The receiver is a web-server that uses HTTP, which uses TCP/IP, for receiving the message from the sender. The figure shows that on the sender it is the browser that uses the method of invention while on the receiver it is the web-server that uses the method of invention.

FIG. 6 is a diagram illustrating an example of two parties according to an embodiment of this invention, wherein the method, as applied by the sender and the receiver, is on a part of a part of a data-unit as opposed to on the whole data unit or a part of a data unit. More specifically, the method is applied on a part of an HTTP body, which is a part of the HTTP message that contains two parts, HTTP header and HTTP body.

FIG. 7 is a diagram illustrating an example of two parties according to an embodiment of this invention, wherein the Differential Information is stored at the beginning of the transferred modified data-unit, which is a part of the HTTP body. The figure shows a diagram of an HTTP message containing the HTTP Header and HTTP Body. The modified data-unit is a part of the HTTP Body. Differential Information is located at the beginning of the modified data-unit.

FIG. 8 is a diagram illustrating an example of two parties according to an embodiment of this invention, wherein the Differential Information is interspersed within the modified data-unit while where Differential Information is located is identified using Escape sequences. The figure shows the HTTP message containing HTTP Header and HTTP Body. The HTTP Body, possibly as one of its parts, contains the modified data-unit transferred within the HTTP Body. Furthermore, the modified data-unit contains a number of parts, with the second part being the first part of the Differential Information. The last part of the modified data-unit is the last part of the Differential Information. Each portion of the Differential Information is identified at its beginning by a Begin-Differential-Information Escape Sequence and ends with an End-Differential Information Escape Sequence (the figure does not show the escape sequences themselves). For instance, the Begin-Differential-information Escape Sequence may be a sequence of “ESC*” characters, while the End-Differential-Information Escape Sequence may be a sequence of “ESC=” characters. Of course, as is customary with the use of escape sequences, any occurrence of the ESC character within the modified data-unit would need to be replaced by an escape sequence, such as “ESCESC” in order for it not to be confused with the other escape sequences.

FIG. 9 is a diagram illustrating an example of two parties according to an embodiment of this invention, wherein the Differential Information is interspersed within the modified data-unit while where it (Differential Information) is located is identified using absolute addressing. Instead of absolute addressing, the method can use relative addressing in which the address of the byte-address of the next portion of the Differential Information would be relative to the location of where the relative-address itself is located.

FIG. 10 is a diagram illustrating an example of two parties according to an embodiment of this invention, wherein the new data-unit is an HTTP message consisting of the HTTP header and the HTTP payload/body, which contains a reply from a web-service. The web-service reply (SOAP envelope) in turn, consists of the Header and the Body. The figure shows an example when the method of invention is applied on the Web-service-reply Body portion of the SOAP envelope.

FIG. 11 is a diagram illustrating an example of two parties according to an embodiment of this invention, wherein the data-unit is a message of the HTTP layer, which consists of the HTTP header and the HTTP body, which contains a reply from a web-service. The reply consists of an Envelope and Body, while the Body portion of the web-service reply is in a semi-structured form in XML. The method of invention is applied on the body of the reply from the web-service. FIG. 11(a) illustrates an example of a content of the message without application of the method of the invention. FIG. 11(b) shows an example of the result of applying the method of invention on the data-unit—the XML Name element containing Brown was removed by the method because it appeared in the previous message (which is not shown in the figure). FIG. 11(c) illustrates how the method of invention can be augmented with a method of replacement of the XML tags by the tag-codes—instead of the tags <Name>, <FirstName>, and <LastName> their corresponding codes <1>, <2>, and <3> are used, respectively.

FIG. 12 is a diagram illustrating an example of two parties according to an embodiment of this invention, wherein the sender, which invokes the method of invention, is the web service executing on the remote server, while the receiver, which invokes the method of invention, is the application, on the mobile device, that has requested the bus schedule.

FIG. 13 is a diagram illustrating an example of two parties according to an embodiment of this invention, wherein the sender, which invokes the method of invention, is the platform housing the web services while the receiver, which invokes the method of invention, is the framework that facilitates invocation of web services on the mobile device.

FIG. 14 is a diagram illustrating an example of two parties according to an embodiment of this invention, the sender, which invokes the method of invention, is the operating system on the remote server, referred to as the remote OS, that receives a request for an execution of the web service, invokes the web service, and returns the reply, while the receiver, which invokes the method of invention, is the operating system on the mobile device, referred to as the mobile OS.

FIG. 15 is a diagram illustrating an example of two parties according to an embodiment of this invention, wherein the sender, which invokes the method of invention, is the remote method, which is invoked by the application on the mobile device and obtains the bus schedule, while the receiver is the mobile application that receives the bus schedule from the remote method and uses the method of invention to re-insert the bus stops and their times that were removed by the remote method.

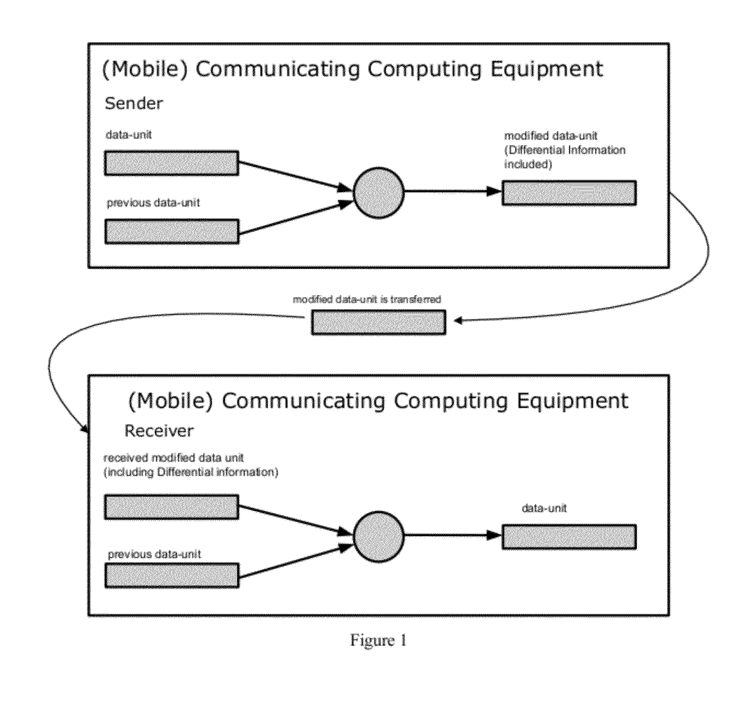

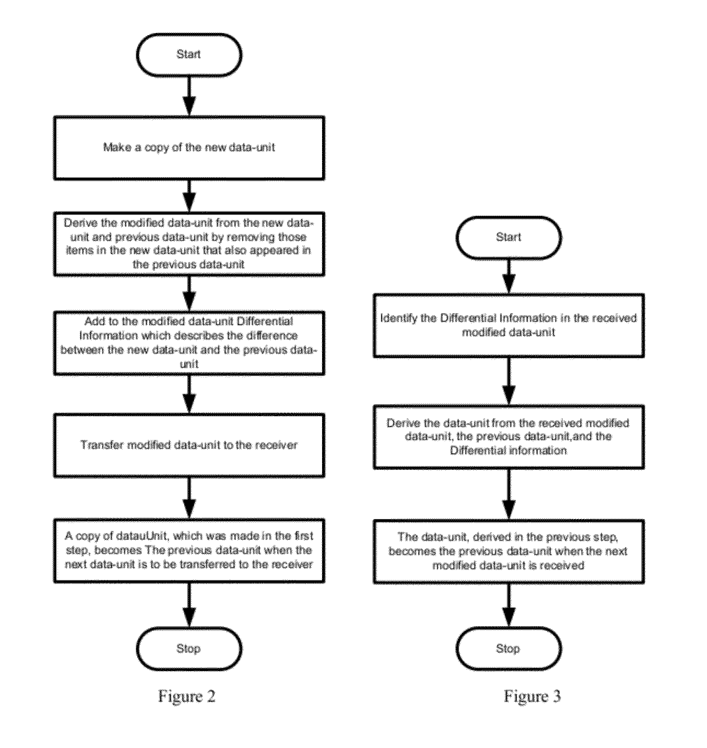

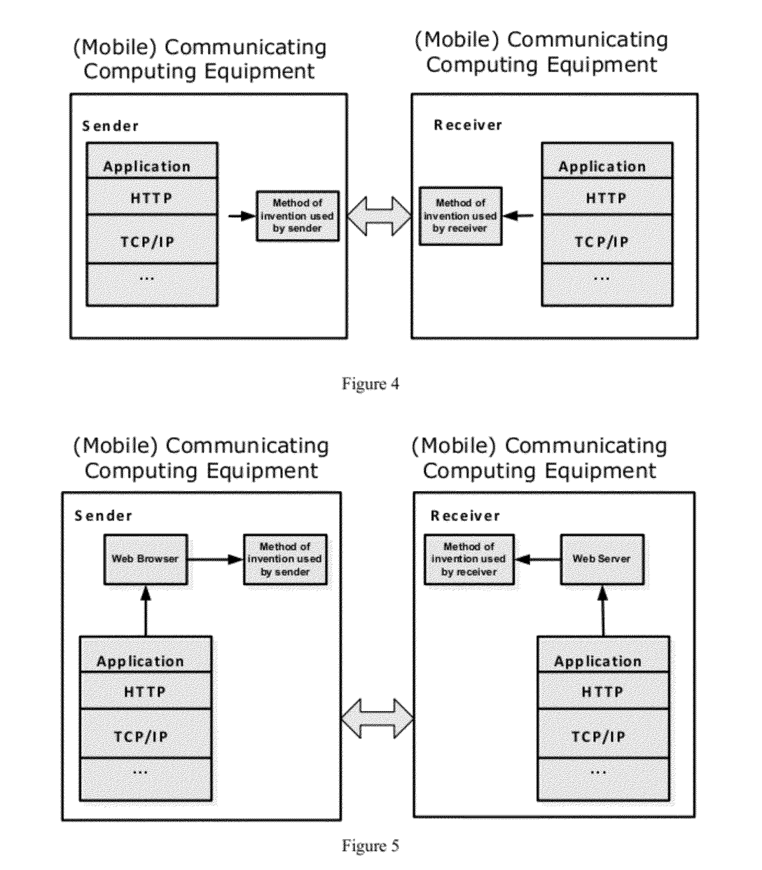

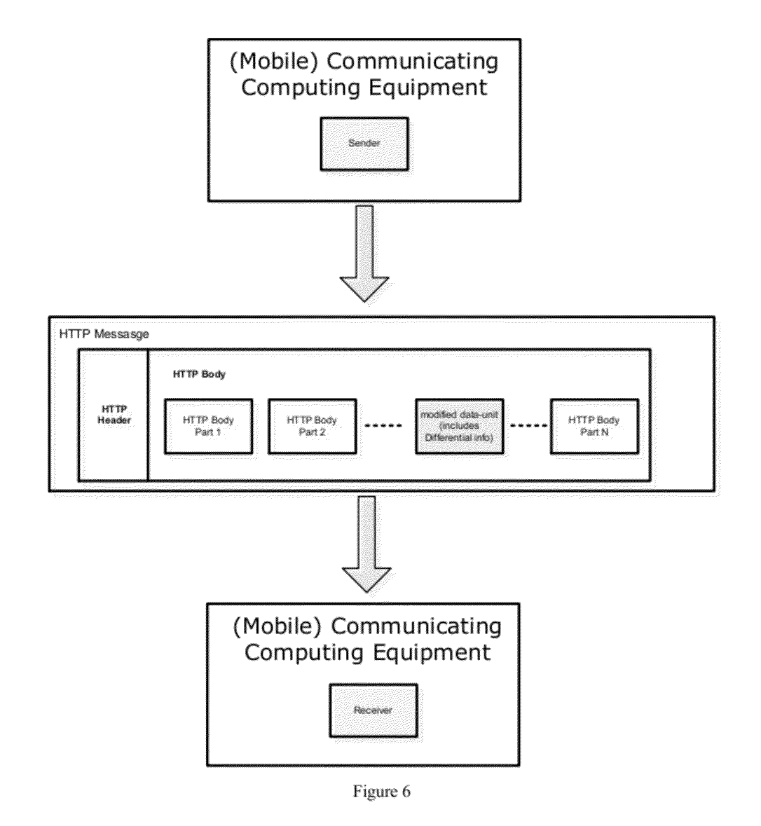

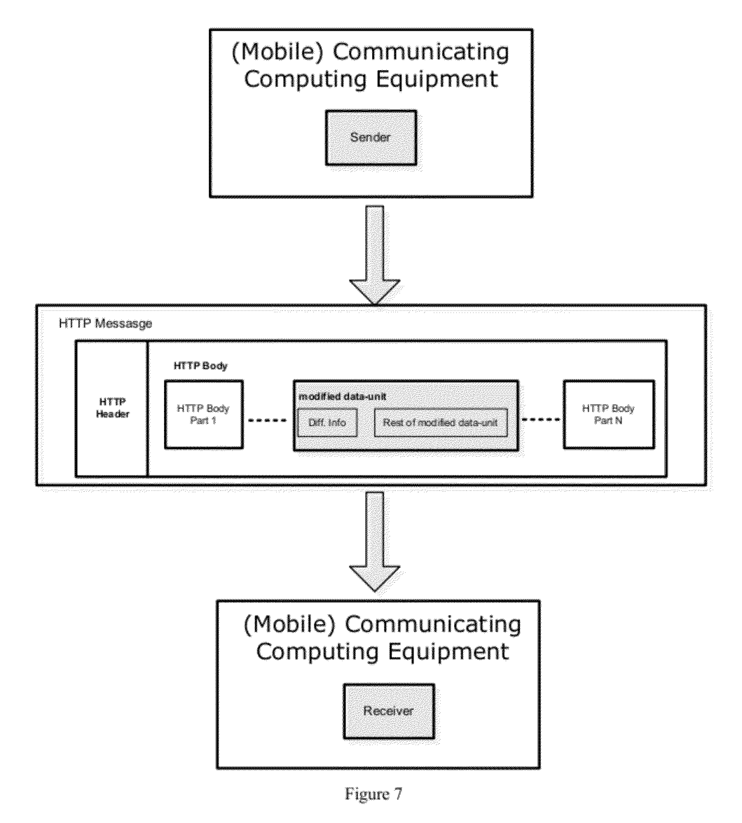

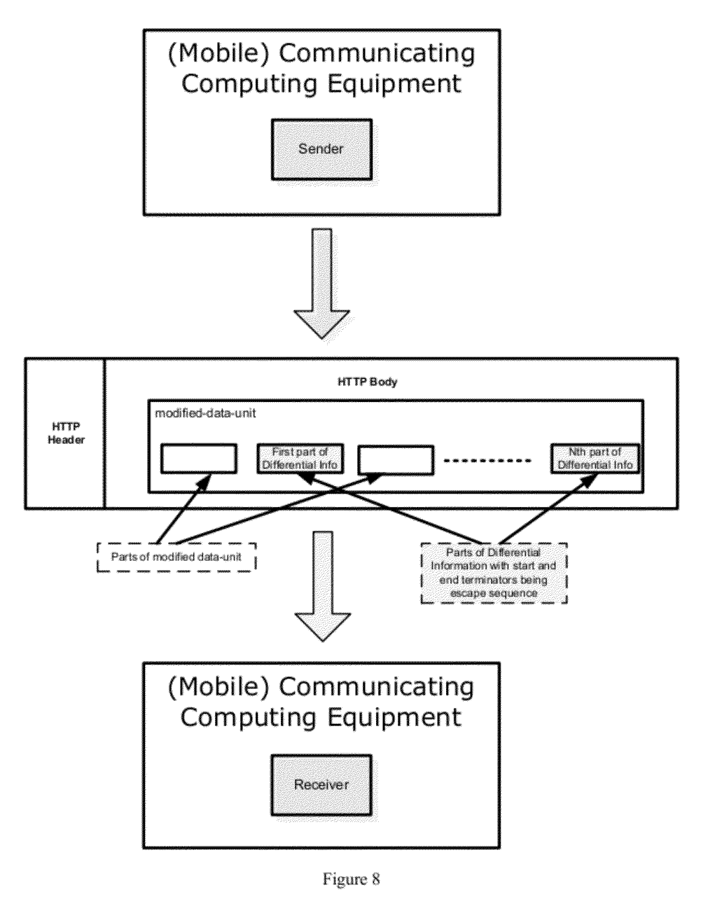

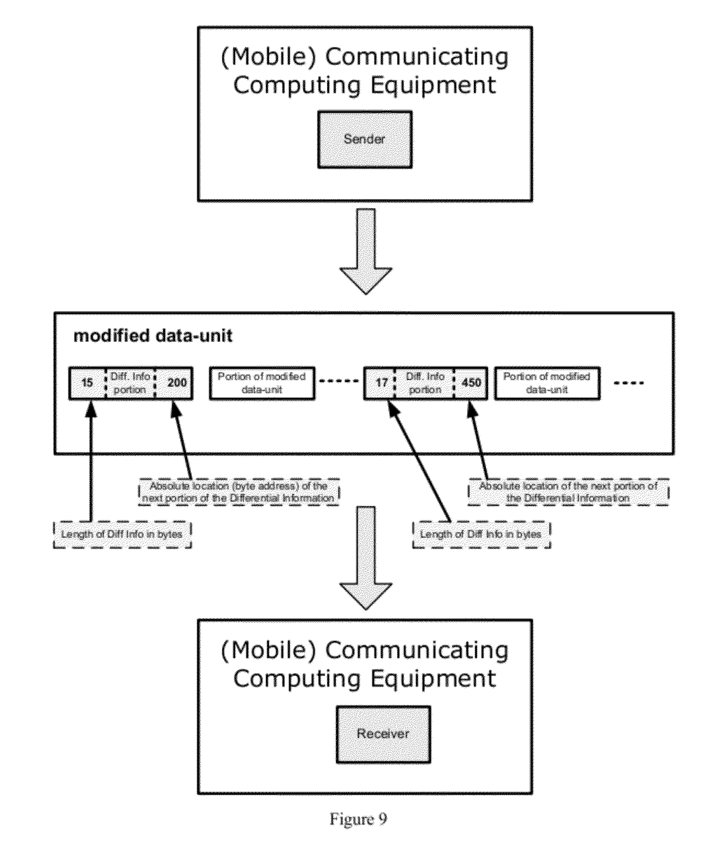

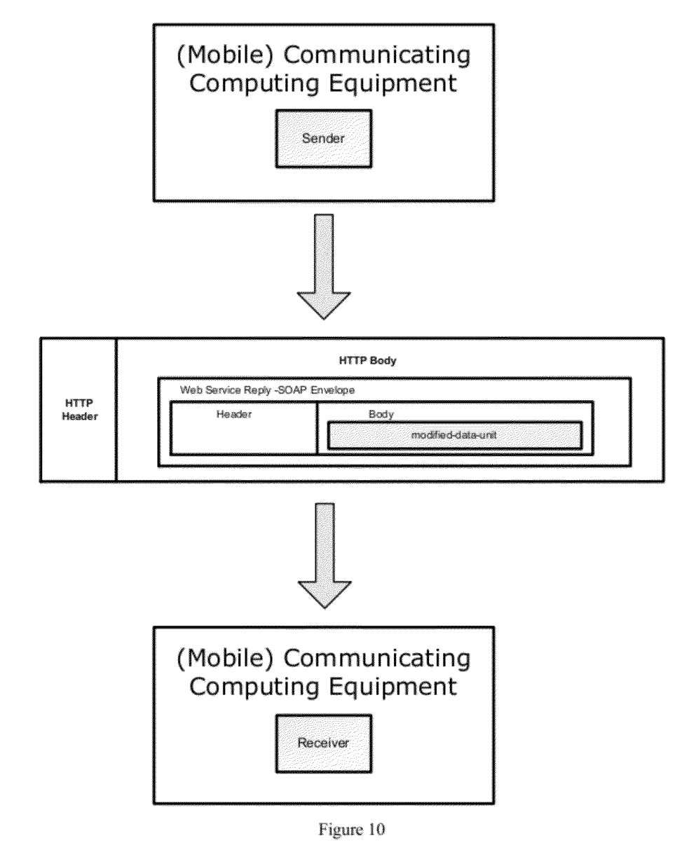

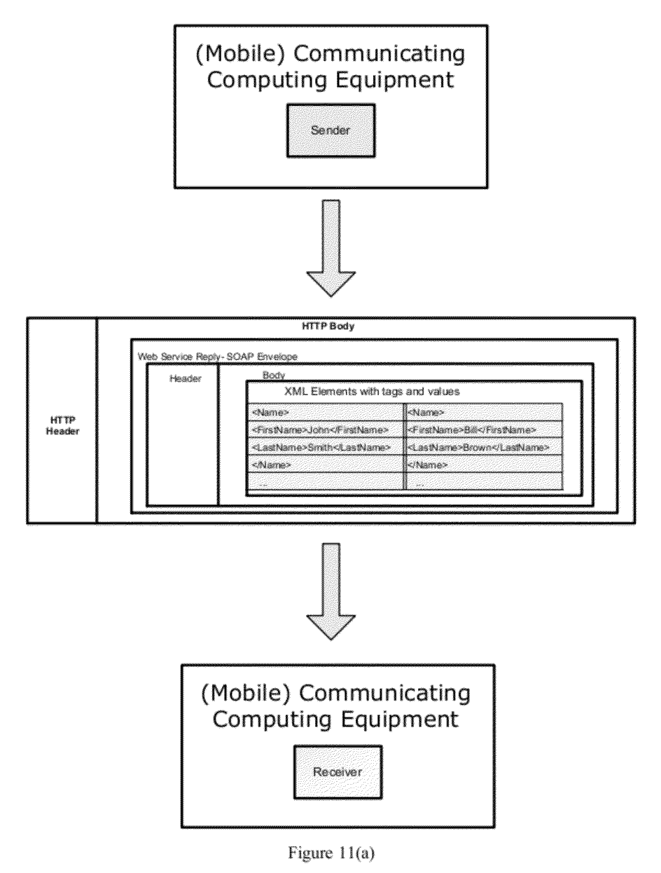

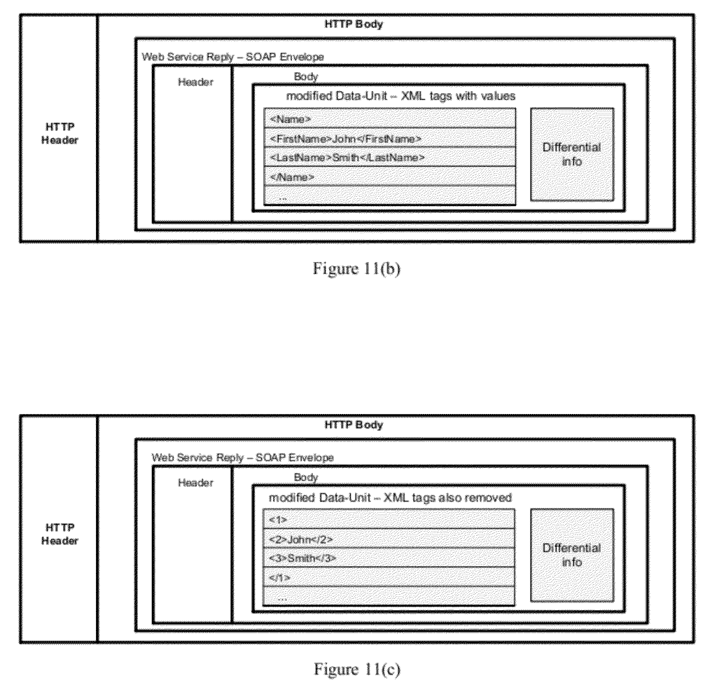

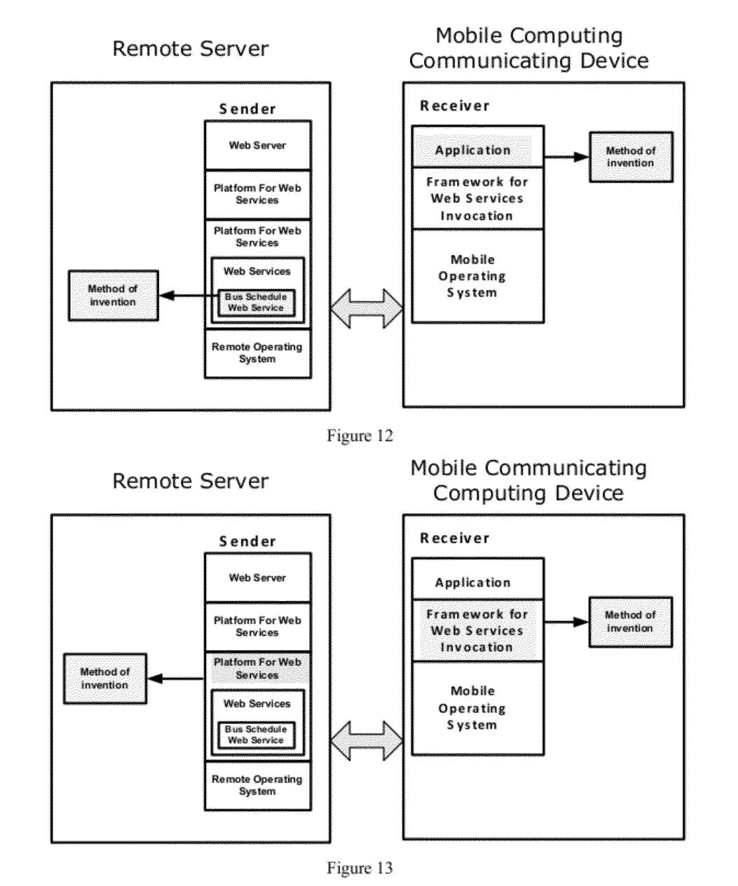

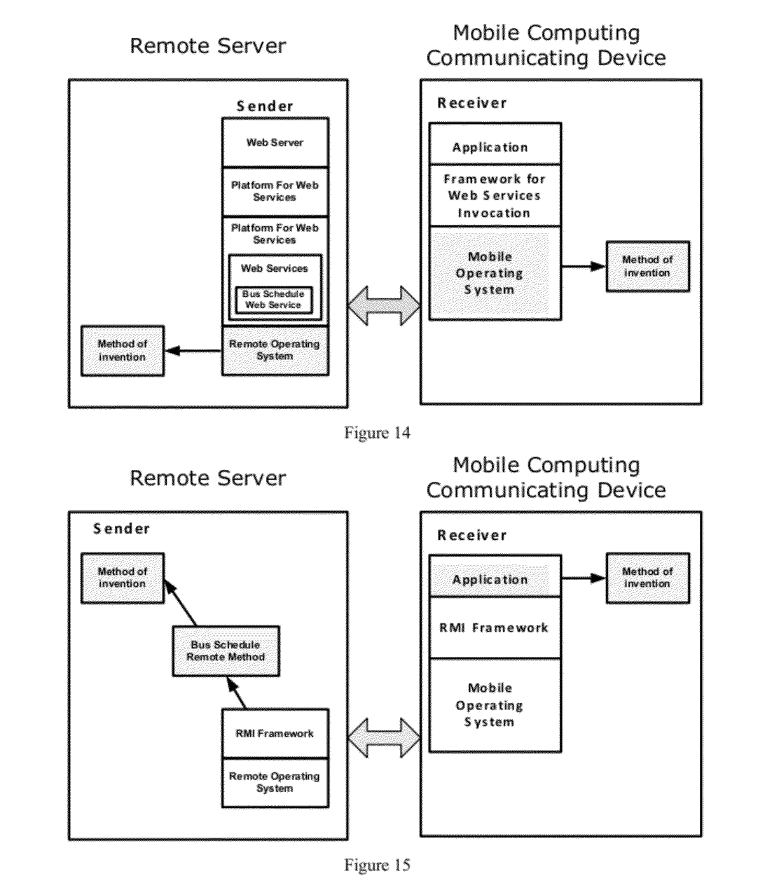

### DETAILED DESCRIPTION OF INVENTION

The present invention provides for the reduction of the size of data-units that are sent in one direction from a sender to a receiver. Consider communication in one direction, in which data units are sent/transferred from the sender to the receiver.

If a data-unit to be sent contains some parts that are the same as in the previous data-unit, then those parts are not sent again when using the method of invention: the sender first makes a copy of the data-unit and then modifies the data-unit by removing those parts from the data-unit that are the same as in the previous data-unit. A copy of a data-unit made by the sender serves as a previous (sent) data-unit when the subsequent data-unit is to be sent. To identify which parts of the data-unit are the same as in the previous data-unit, the sender compares the data-unit with the previous data-unit. In addition to removing those parts of the data-unit that are the same as in the previous data-unit, the sender also includes, in the modified data-unit, information that describes how the data-unit differs from the previous data-unit—this information is referred to as Differential Information and assists the receiver in reconstruction of the data-unit from the received modified data-unit.

When the modified data-unit arrives at the receiver, the receiver compares the received modified data-unit with the previous data-unit and also utilizes the Differential Information to reconstruct the data-unit (which was used by the sender to create the modified data-unit that was actually sent and received by the receiver).

The method of invention is used to reduce the size of data transferred over the network when some parts of data units are the same as in the previously sent data units. However, the method of invention is only applicable in situations in which the receiver receives the data-units in the order that they were sent by the sender. There are many examples of communication environments where this is true. For instance, ordering of data-units can be a property that is ensured by the underlying communication mechanism, such as when communication of data-units is achieved by using TCP/IP for delivery of data-units—the TCP/IP protocol ensures that the data-units are delivered in the order that they were sent. Another example includes a point-to-point communication between the sender and receiver, wherein the sender and receiver exchange data-units directly without the data-units being passed through third parties. In another example, the sender and receiver themselves may ensure that the data-units are logically received in the order that they were sent, for instance, by using sequence numbers embedded in data-units: although the data units may not be received physically in the order that they were sent, the receiver uses the sequence numbers, inserted by the sender, to order the received data units logically into the order in which they were sent.

Differential Information describes how the content of a data-unit differs from the content of the previous data-unit as it relates to the removal of those parts of the data-unit that also appeared in the previous data-unit. In particular it identifies which parts of the data-unit did occur in the previous data-unit and/or which parts of the data-unit did not occur in the previous data-unit. Consider the following examples of Differential Information for a data-unit that consists of parts p1, p2, p3, and p4 and assume that parts p2 and p4 of the data unit are the same as in the previous data-unit. The modified data-unit contains parts p1 and p3 (as parts p2 and p4 were removed by the sender) and Differential Information.
(i) In this first example, Differential Information identifies the parts that were removed, i.e., it identifies parts p2 and p4 in the previous data-unit and also where they should be inserted into the received modified data-unit.
(ii) In this example, Differential Information identifies parts p1 and p3 that are different from the previous data-unit and where they are located in the data-unit. For reconstruction, the receiver deduces that parts p2 and p4 have been removed and that they need to be obtained from the previous data-unit and inserted into the received modified data-unit.
(iii) In this example, Differential Information contains information on the removed parts p2 and p4 and also on the parts p1 and p3 and the receiver reconstructs the data-unit from the modified data-unit by inserting parts p2 and p4 from the previous data-unit into the modified data-unit that was received. In this case, the receiver has more than sufficient information to reconstruct the data-unit.
(iv) Differential Information can also be based on a combination of the above examples even though such Differential Information may appear to be less clear than in the above examples.
(v) Differential Information may, in certain situation, be either null or specific to the nature of the data-units.

Claim 1 also relates to the application of the method to not just on a part of a data-unit but also, recursively, on a sub-part of the data-unit. Consider, for instance, a data-unit that is an HTTP message requesting an execution of the web service using the HTTP protocol. The HTTP message contains two parts, the header and the body, while the web service request is included in the HTTP body. The web service request itself includes the name of the web service and also input parameters (if any). If an application repeatedly requests an execution of a web service, the name of the web service will not change and is subject to removal by the method of invention. The name of the web service is a part of the web service request, which is contained as a part of the HTTP body, which itself is a part of the HTTP message.

The method of invention is applicable on structured, unstructured, and semi-structured data appearing in data-units. In case the data is unstructured, a data-unit is simply considered to be a sequence of bytes (or other units such as words, where a word is a fixed number of bytes) and a part of a data-unit is a simple particular sub-sequence of the data-unit. Thus a (sub)part of a data-unit is simply identified by the length of the subsequence and its location within the data-unit. Identification of a (sub)part may be achieved by using absolute addressing, relative addressing, or a combination of the two, or in conjunction with the length of (sub)parts information. The units of length or addresses are typically bytes. In absolute addressing, the location of the (sub)part is identified by an address expressed in relation to the beginning or the end of the data-unit. For instance, the address of a (sub)part may be expressed by stating that the first byte of the (sub)part is the n-th byte from the beginning of the data-unit. In relative addressing, the address is expressed in relation to the previous (sub)part. For instance, the address of the (sub)part may be expressed by stating that the first byte of the (sub)part is the n-th byte from the beginning of the previous data (sub)part. If the length of (sub)parts is encoded within the (sub)parts themselves, then this length may be used to identify the beginning of the next (sub)part relative to the beginning of the (sub)part in which the length is located.

Claim 2 relates to a situation in which the two parties agree, either by design or at the beginning of the communication or using in-band signaling, that only certain (sub)parts of the data-unit will be subject to removal. This is particularly applicable to data-units that contain structured or semi-structured data known to both the sender and the receiver. Examples of the structured data-units include messages of the HTTP protocol, segments of the TCP protocol, and packets of the IP protocol. Data units containing data expressed using XML would be the most prominent example of the data-units containing semi-structured data. For instance, request and reply messages used in web-service invocations are examples of data-units containing semi-structured data encoded using XML.

When the sender and receiver agree that only certain (sub)parts of the data-unit will be subject to removal, instead of keeping a copy of the whole data-unit, the sender and the receiver keep only a copy of those (sub)parts that are subject to the removal. Furthermore, since there is an agreement on which (sub)parts of the data-unit are subject to removal, the sender does not compare the whole data-unit with the previous data-unit, but instead only compares those (sub)parts in the data-unit with the corresponding (sub)parts of the previous message that the sender and the receiver agreed that they be subject to removal. Consider, for instance, a data-unit that is a repeated request for an execution of a web service. As it is the same web service invoked by an application, the name of the web service will not change. When the agreement is by design, the method of invention is included in the implementation of the sender and receiver of HTTP protocol: on the sender, the method of invention makes a copy of the web service name when it first appears in the first HTTP message as a result of the first execution of the web service, and removes them from subsequent HTTP requests (if the requests are for the same web service). On the receiver, the method of invention makes a copy of the web service name appearing in the first request and then re-inserts them in subsequent received modified data units in order to re-create requests. Instead of an agreement by design, however, a more likely scenario is for the sender and the receiver to negotiate, upon the first request for an execution of the web service in certain period of time (such as a day or a week), whether the method of invention is to be used and on which parts, or sub-parts, of the message the method is to be applied. The differential information may be null in certain situations where it is known by the sender and the receiver that the values of (sub)parts of the message will not change after the first appearance.

Claim 3 relates to how the differential information is included in the modified data-unit sent from the sender to the receiver. The sender and the receiver may have an agreement, either by design or negotiated at the beginning of communication, on the specific ways on how to include the differential information in the modified data-unit—the differential information may be included at the beginning or the end of the data-unit, or the differential information may be included using other ways that are described in claim 3. In a negotiated agreement, for instance, the sender and the receiver may negotiate how the differential information is included in the modified data-unit. For instance, in the TCP protocol, in the session establishment (first SYN message) the sender may offer to the receiver that the differential information be included using some specific method (i) or (ii), while the receiver may in the SYN reply message indicate that it chooses method (i), where the method (i) may be inclusion of the Differential Information at the beginning of the message while the method (ii) may be inclusion of the differential information at the end of the modified data-unit. Other methods for inclusion of the differential information in the modified data-unit are also described in claim 3.

Note that the method of invention applies to semi-structured data-units that utilize tags to describe parts or sub-parts, such as using XML, wherein both parties agree upon tags that are in use. In fact, the method of invention is particularly applicable to exchanged data-units that contain data encoded using XML. Another example of where the method of invention applies is an exchange of request and reply messages exchanged when web services are invoked.

Although XML is used in examples, the claim is general and is applicable to other encoding schemes applied in semi-structured data contained in the exchanged data-units. Because the tags are textual in XML and convey semantic meaning targeted to human recognition, they are lengthy. Frequently, in order to decrease the size of data-units containing data encoded in XML, it is a customary practice to reduce the size of exchanged data-units by replacing the lengthy XML tags with agreed-upon tag-codes that are much shorter in length than their corresponding tags. Thus, before sending the data-unit, the sender replaces the tags with the tag-codes while the receiver replaces the tag-codes with the corresponding XML tags. The replacement of tags with tag-codes by the sender and of tag-codes with tags, may be incorporated into the method of invention as applied by the sender and by the receiver.

What is claimed is:

1. Two communicating pieces of computing equipment, including computers, routers, switches, mobile computers, and/or mobile computing devices, referred to as parties, of which one or both can be mobile, having memory, a processing function, and a communication function used for synchronous or asynchronous exchange of messages/data-units; a method for modifying the messages/data-units by parties, wherein the sender, which is to send a new data-unit, will modify it using the method to: make a copy of the to-be-sent data-unit, where that copy will be used as the previous data-unit when the next new data-unit is to be sent, and then to compare the to-be-sent data-unit to the previous data-unit and identify which (sub)parts of the to-be-sent data-unit have the same content as those of the previous data-unit, and create a modified data-unit by (i) removing those (sub)parts of the to-be-sent data-unit that have the same content as those of the previous data-unit, and create differential information that describes how the modified data-unit differs from the previous data-unit, and (ii) by adding the differential information to the modified data-unit; and by sending the modified data-unit (which includes the differential information) to the receiver; and wherein a party, the receiver of the modified data-unit, will derive the newly received data-unit using the method to: use the received modified data-unit, including the differential information contained therein, and the previous data-unit to derive the newly received data-unit from which the sender created the modified data-unit, and then to make a copy of the new data-unit wherein that copy will be used as the previously received data-unit the next time a modified data-unit is received (and the method is used to derive from it the new data-unit). The method can be applied by the sender or a receiver recursively on a part, or a sub-part, of a data-unit, instead of or in addition to applying it on a data-unit. Consequently, in the first level of recursion, any reference to a data-unit means a reference to a part of the data-unit, while a reference to a part of the data-unit means a reference to a sub-part.

2. Two communicating parties according to claim 1, wherein data-units are structured or semi-structured, in that parts of the data-unit, or sub-parts of parts of a data-unit are (i) in structured form in that they are pre-defined and their location within the message is known because it is fixed or it is known because the length, in bytes or some other units such as bits, of the (sub)parts are known, or are (ii) semi-structured in that (sub)parts of data-units are described using tags, such as in XML, wherein a tag is identified by special characters at its beginning and its end, and is used to identify and describe a subsequent part or sub-parts of a data-unit, and wherein which (sub)parts of the data-unit are subject to removal, by the method of invention used by the sender, and re-insertion, by the method of invention used by the receiver, is known either by design, i.e., a priori to communication, or it is agreed to by the sender and the receiver at the beginning of communication. The method of invention for modifying the data-units, or their (sub)parts, by the parties, wherein the sender, which is to send a new data-unit, will modify it using the method to: make a copy of the (sub)parts, which are subject to removal if they have the same content as the corresponding (sub)parts of the previous data-unit, where such copies will be used as (sub)parts of a previous data-unit when the next new data-unit is to be sent, and then to compare those (sub)parts, of the new data-unit that are subject to removal, to the corresponding (sub)parts of the previous data-unit and identify which parts of the new data-unit have the same content as those of the previous data-unit, and create a modified data-unit by (i) removing those (sub)parts of the new data-unit that have the same content as those of the previous data-unit, and create a differential information that describes how the new data-unit differs from the previous data-unit, and (ii) by adding the differential information to the modified data-unit; and by sending the modified data-unit to the receiver; and wherein a party, the receiver of the modified data-unit, will derive the new data-unit using the method of invention to: use the received modified data-unit, including the differential information contained therein, and the (sub)parts of the previous data-unit to derive the new data-unit, from which the sender created the modified data-unit, and then to make a copy of those parts of the data-unit that are subject to removal, wherein such copies will be used as (sub)parts of the previous data-unit the next time a modified data-unit is received (and the method is used to derive from it the new data-unit).

3. Two communicating parties according to claims 1 and 2, wherein the differential information contains the description of which parts of the new data-unit were removed and/or which parts of the new data-unit did not appear in the previous data-unit and, further, wherein this differential information is located in the modified data-unit, either as whole, or in parts using (i) positioning/placement, as agreed-to by the parties either by design prior to communication or at the beginning of communication, within the modified data-unit relative to the beginning, or relative to the end of the modified data-unit, or relative to a part of the modified data-unit, such as for example the differential information, or a part of the differential information, being located at the beginning of the modified data-unit, or at the end of the modified data-unit, or at the 50^{th} byte of the modified data-unit, or the 1^{st} byte after the previous part; or (ii) using indirection wherein first (i) above is used to describe where the information on the location of the differential information is within the transferred-modified data-unit.
